(19) United States
(12) Patent Application Publication
(10) Pub. No.: US 2007/0223686 A1
(43) Pub. Date: Sep. 27, 2007

(54) Methods and apparatus for data and signal encryption and decryption by irregular subspace leaping

(76) Inventor: Shidong Li, Daly City, CA (US)

Correspondence Address: Shidong Li, 29 Fairway Drive, Daly City, CA, 94015, US

(21) Appl. No.: 11/228,910

(22) Filed: Sep. 16, 2005

Related U.S. Application Data
(60) Provisional application No. 60/610,415, filed on Sep. 16, 2004.

(51) Int. Cl. H04L 9/28

(52) U.S. Cl. 380/28

(57) ABSTRACT

A data/signal encryption/scrambling and decryption system and methods for constructing said system from irregular subspace leaping. A data/signal is mounted from the first/previous subspace to the second/subsequent subspace. A non-orthogonal complement subspace of the first/previous subspace in the second/subsequent subspace is generated, and spanned by the y-vectors. An encrypting/scrambling data component is generated by either a random combination of the said y-vectors, or by a projection of a partially coherent (with the given data/signal) data onto the span of y-vectors. The encrypting/scrambling is then carried out by combining the given data/signal with the said scrambling data component. The decryption method makes use of pseudoframes for subspace. A set of x-vectors associated with the said y-vectors are evaluated under the principle that the span of x-vectors is orthogonal to the span of y-vectors, and an orthogonal projection of the span of x-vectors covers the first/previous subspace. The said x-vectors forms a pseudoframe for the first/previous subspace. A dual pseudoframe sequence is determined and the decryption is carried out using the pseudoframe expansion with sequences x-vectors and its pseudoframe dual. The said method is fast since it operates on relatively small segments of the data set. The said method has the characteristics that the said scrambling data component is completely unknown to anyone including the message generator/sender, and the said non-orthogonal complementary subspaces have nearly infinite many choices. The combination of the above two uncertainties ensures high security of the present methods.

### CROSS-REFERENCE TO RELATED APPLICATIONS

This application is related to and claims the benefit of U.S. Provisional Patent Application 60/610,415, entitled “Methods and Apparatus for Data and Signal Encryption and Decryption by Irregular Subspace Leaping”, filed on Sep. 16, 2004, which provisional application is incorporated in its entirety by reference into the present application.

### FIELD OF THE INVENTION

The present invention generally relates to the construction of data/signal encryptions and scrambling and decryptions software and hardware/chips for secure data/signal transmissions over the wired and wireless communication and internet networks, and more particularly to the construction of such secure transmission software and hardware systems with fast implementation and completely different mechanism than conventional methodologies.

### DESCRIPTION OF THE RELATED ART

Data/signal transmission security in today's communication and internet network systems is becoming more and more a critical issue in all societies and countries in the world. Everyone's daily life is being affected by how secure a network and communication system is. Personal online banking, business financial data communications among banks and corporations, banking automations in bank systems, secure internet data distributions and transmissions all use one type of encryption and decryption method or another. Still, hacker attacks and identity theft have become huge problems in the information age, enough to make even the most carefree individual a tad paranoid. In year 2002, Visa and MasterCard reported that fraud losses topped $1 billion. The U.S. Justice department said 700,000 Americans are victims of identity theft every year. CardCorps listed more than 100,000 stolen credit card numbers gathered from Internet chat rooms where thieves have been checking to determine whether the numbers are still good to use.

Common techniques used among the world are mostly derived from number-theoretical algorithms such as RSA, AES and SHA hash authentication methods.

RSA encryption, named after its inventors, Ron Rivest, Adi Shamir and Leonard Adleman transforms a number X into the number Y with the formula Y=X^{a} (mod N), where a and N are two numbers derived from a principle of prime number factorization. The RSA approach is based on the fact that factoring a large number into the product of two prime numbers is extremely difficult. RSA is widely studied by both users and attackers. There have been numerous attacks against RSA over the last 20 some years. An article “Twenty years of attacks on RSA cryptosysmte”, by Dan Boneb, Notice of AMS, February, 1999, described in great detail what these attacks do, and where the problems are. Though RSA is still theoretially safe, attacks on RSA has caught notible attention.

AES stands for Advanced Encryption Standard, also known as Rijndael. The cipher was developed by two Belgian cryptographers, Joan Daemen and Vincent Rijmen, and submitted to the AES selection in 1998. AES is a block cipher later adopted as an encryption standard by the US government. Typical block size 128 bits, and key sizes are 128, 192 and 256 bits. It is a substitution-linear transformation network with 10, 12 or 14 rounds, depending on the key size. While AES is expected to be used worldwide and analyzed extensively, concerns over the security of AES still exist. Some feel that the margin between the number of rounds specified in the cipher and the best known attacks is too small for comfort. The risk is that some ways to improve these attacks might be found and that, if so, the cipher could be broken. In this meaning, a cryptographic “break” is anything faster than an exhaustive search, so an attack against 128-bit key AES requiring ‘only’ 2¹²⁰ operations would be considered a break even though it would be, now, quite infeasible.

SHA stands for Secure Hash Algorithm. The most popular hash algorithm nowadays is the SHA-1. Hash functions are so-called one-way functions. They are used in conjunction with public-key algorithms for both encryption and digital signatures. They are used in integrity checking, and in authentication. Hash functions suppose to have two properties. For one, they're one way. This means that it is easy to take a message and compute the hash value, but it's very hard to take a hash value and recreate the original message. Two, they're collision free. This means that it is exceedingly hard to find two messages that hash to the same (hash) value. For a long time, SHA-1 is believed break-free. But just in August, 2005, a group of Chinese cryptographers showed that SHA-1 is not collision-free. That is, they developed an algorithm for finding collisions 2000 times faster than brute force. Some experts sighed that they “expected this to happen, but not nearly this quickly and not nearly this impressively”. Some even suggests that we should start to walk away from SHA, although the continuing application of SHA-1 is still highly expected. The Chinese cryptographers' work is not yet a break to the SHA algorithm, but somewhat a “confidence” shake-up.

While these systems are currently widely used and relatively (or even theoretically satisfactorily) safe, the increasing number of security breach, identity thefts, as outlined earlier pose urgent need for systems of greater security. Survey studies show that security concerns are becoming one of the most critical issues in modern life. One way to elevate the security of communication systems is use even larger prime numbers in the current RSA approaches, and implement the algorithms extremely carefully by the theory (some less secure systems are because of the sloppy implementation and the lack of complete understanding of the theory). However, there is a limit to what these algorithms can do due to the decryption complexity and time concerns.

There is also an area where the security measure is very weak, namely, the wireless communication arena Mobile to mobile communications have almost no effective security mechanisms implemented. Wireless LAN communications has some very limited protections in this regard. One way to add some security measures to these real time systems is to use certain scrambling techniques available. But those techniques typically operate at long data samples to ensure certain probability of security. But long data length processing is against the real time need. In short, a major problem in real time system security is the lack of fast and secure encryption and decryption methodologies that fit the fast real time characteristics of those communication platforms.

Thus, there are needs to develop different and fast secure encryption and decryption methods: systems that are simple and operate fast, and can work either independently or as a complement to existing security schemes to provide better protection to communication systems.

### BRIEF SUMMARY OF THE INVENTION

The present invention is directed towards the above needs. The present invention includes a method for constructing a data/signal secure transmission systems that operate independently or in complement to existing encryption and decryption systems for improved security. The present invention utilizes a set of new techniques of subspace leaping by bringing the original data/signal into a sequence of totally different subspaces that are formed by adding the original/previous subspace with one of its unknown non-orthogonal complementary subspaces. As if adding more irregular dimensions to human's 3D perception system, a human would have either a total loss of the perception of a transformed object or a unrecognizable delusion of the object without an accompanying decryption mechanism A security system in accordance with the present invention has the potential to carry out real time tasks.

A method in accordance with the present invention is a method for constructing an encryption/scrambling and decryption software and/or hardware (such as a microchip) systems for secure data/signal transmission and authentication over wired and wireless communication and internet networks.

The encryption method includes a transformation of the first data/signal in the first/given subspace into a second data/signal in the second (and different) subspace, a construction of the said second subspace via a non-orthogonal direct sum of the first subspace and a non-orthogonal complement subspace of the first subspace in the second subspace, a construction of the said non-orthogonal complement subspace via a sequence of y-vectors in the second subspace, generating an encrypting/scrambling signal in the said non-orthogonal complement subspace spanned by the said y-vectors, adding the said scrambling signal, which is non-orthogonal to the first data/signal, and performing an optional pseudoframe transformation prior to data/signal transmission. The subspaces that the data/signal leaps into are typically Euclidian vector spaces. The non-orthogonal direct sum of two subspaces is a way to form a new (the second) subspace in which every element can be written as the sum of two elements from the two subspaces, respectively. The y-vectors is a set of vectors in the new (the second) subspace that spans a (non-orthogonal) complementary subspace of the first subspace in the second subspace. A complementary subspace of the first in the second is one that is a mathematical difference of the second and the first subspaces in such a way that it shares with the first subspace only the zero vector. More particularly, the pseudoframe transformation is an inner product of the final data/signal with a pseudoframe sequence. The inner product is defined because of the pseudoframe representation imposed to a subspace. Such a pseudoframe representation also defines pseudoframe sequences with respect to the subspace, which is described in “A theory of generalized multiresolution structure and pseudoframes of translates”, by S. Li, J. Fourier Anal. Appl. 7 (2001), no. 1, pp 23-40, and in “Pseudoframes for subspaces with applications”, by S. Li and H. Ogawa, J. Fourier Anal. Appl. 10 (2004), no. 4, pp 409-431.

The decryption method includes a recovery of the pre-transmission signal (scrambled) through a pseudoframe reconstruction if so indicated in the received signal that a pseudoframe transformation took place before the transmission, a construction of a sequence of (decryption) x-vectors, a construction of a pseudoframe, using the said x-vectors, for the subspace where the original/previous data/signal resides in, a construction and a linear operation of a non-orthogonal projection of the received data/signal onto the original/previous subspace. The pseudoframe reconstruction is so given in the pseudoframe representation. The (decryption) x-vectors are a set of vectors whose span equals to the orthogonal complement of the span of y-vectors (used in the encryption) in the current signal subspace, and whose span (x-vectors) covers the original/previous subspace through an orthogonal projection. The pseudoframe construction using the x-vectors are part of the theory of pseudoframes for susbspaces (PFFS) as cited earlier on which this invention is based. The non-orthogonal projection is a projection whose range subspace is the original subspace and whose null subspace contains the span of the said y-vectors (in the encryption) in this application, and is provided by the said PFFS constructed in the last step. The linear operation of the non-orthogonal projection is the linear combination of one set of PFFS elements with the coefficients which are the inner product of the (scrambled) data/signal with another set of PFFS elements (the x-vectors).

The encryption and decryption methods also include recursive applications of the encryption methods and the step-by-step decryption procedures described above in the order of last-in-first-out.

An apparatus in accordance with the present invention includes an independent software system that performs the encryption and decryption operations to data/signal flows in a communication network by means of the present invention.

Another apparatus in accordance with the present invention includes a software plug-in system that performs the encryption and decryption operations, by means of the present invention, in complement (as pre- or post-encryption devices) to other existing security systems.

Yet another apparatus in accordance with the present invention includes a hardware system (such as a microchip) that performs the encryption and decryption operations by means of the present invention in communication devices such as cell phone, land phone sets, communication and relay devices/stations, etc.

One advantage of the present invention is that it operates on much smaller data/signal set (in length) to achieve the security measure. It is therefore a fast encryption and decryption method suitable for real time applications.

Another advantage of the present invention is that it operates on a subspace leaping mechanism with multidimensional unknowns out of the encryption procedures. Much like adding multiple and irregular dimensions to human's 3D perception system, an object represented in the new system is either completely invisible or totally unreadable to human eyes.

The other advantage of the present invention is that it combines multiple random procedures with deterministic ones together besides a shuffling that most encryption methods employ. The random processes include mounting vectors in Sᵢ to Sᵢ₊₁, selecting a set of y-vectors among nearly infinite many possibilities, and randomly projecting a coherent and scrambling signal onto the span of the selected y-vectors. The deterministic process include generating the x-vectors for the selected y-vectors (which is practically infeasible to run the test given the theoretically infinite many choices of y-vectors), and perform an ordered pseudoframe projection on the correct mounting of Sᵢ in Sᵢ₊₁ (among a large number of possible mountings). None of the existing encryption and decryption methods has these many random and deterministic mechanisms combined.

Yet another very important advantage of the present invention is the fact that the said encrypting/scrambling component added to the first/previous data/signal is unknown to anyone including the sender. An attacker would not have a reference to judge if a correct set of x-vectors is being found for the decryption since the said encrypting/scrambling component is completely unknown.

Yet another advantage of the present invention is that it can be used as both a “private key” and an “authentication” cryptosystem. In the private key mode, the index set J_{y} with which the set of y-vectors {yₙ^{(j)}}ₙ(jεJ_{y}) are used, the mounting method of the subspace Sᵢ in Sᵢ₊₁, and the decryption x-vectors are all kept secret. In the authentication mode, the index set J_{y} with which the set of y-vectors {yₙ^{(j)}}ₙ(jεJ_{y}) are used is assigned to user A.

### BRIEF DESCRIPTION OF THE FIGURES

The mechanism and features, aspects and advantages of the present invention will become better understood with regard to the following description, appended claims, and accompanying drawings where:

FIG. 1 shows a flow chart of the steps, in accordance with the present invention, for constructing an encryption system.

FIG. 2 shows a schematic description of one-iteration of the encryption mechanism. The attention is called upon the nearly infinite many possible irregular complementary subspace given by span {yₙ^{(j)}}ₙ.

FIG. 3 shows a flow chart of the steps, in accordance with the present invention, for constructing an decryption system.

FIG. 4 shows a schematic description of one-iteration of the decryption mechanism. The operation of “crushing” the subspace span {yₙ^{(j)}}ₙ is carried out.

FIG. 5 shows a diagram of components, in accordance of the present invention, of constructing a hardware system including a microchip for encryption and decryption.

### DETAILED DESCRIPTION OF THE INVENTION

The present invention relates to a new method for constructing a data/signal encryption and decryption system that is fundamentally different from that of existing methodologies. The present invention functions much like adding multiple and irregular dimensions to human's 3D perception system, an object represented in this new system leaps into an irregular subspace completely different from its original form, and thereby is either completely invisible or totally unreadable to human eyes. Because of the nearly unlimited irregularity of the subspace leaping in the present invention, decoding becomes practically infeasible. The mechanism of the decryption depends on the use of a notion of pseudoframes for subspaces (PFFS) as mentioned earlier, which have infinite redundancy that contributes immensely to the security of the encryption system of the present invention.

The present invention is good for both data and (digital) signal encryption. The present method operates safely on relatively small segments of signal/data streams, the implementation is fast since the length of the segments need not be too long, such as the SAFE signal encryption algorithm, to ensure security, nor digit-by-digit mechanisms such as in other number theoretical encryption algorithms.

The present invention uses vectors and matrices in computation. These matrices are well-suited to current digital signal processors and other common microprocessors. The operations of the present invention can also be easily implemented in contemporary FPGA or ASIC chip sets.

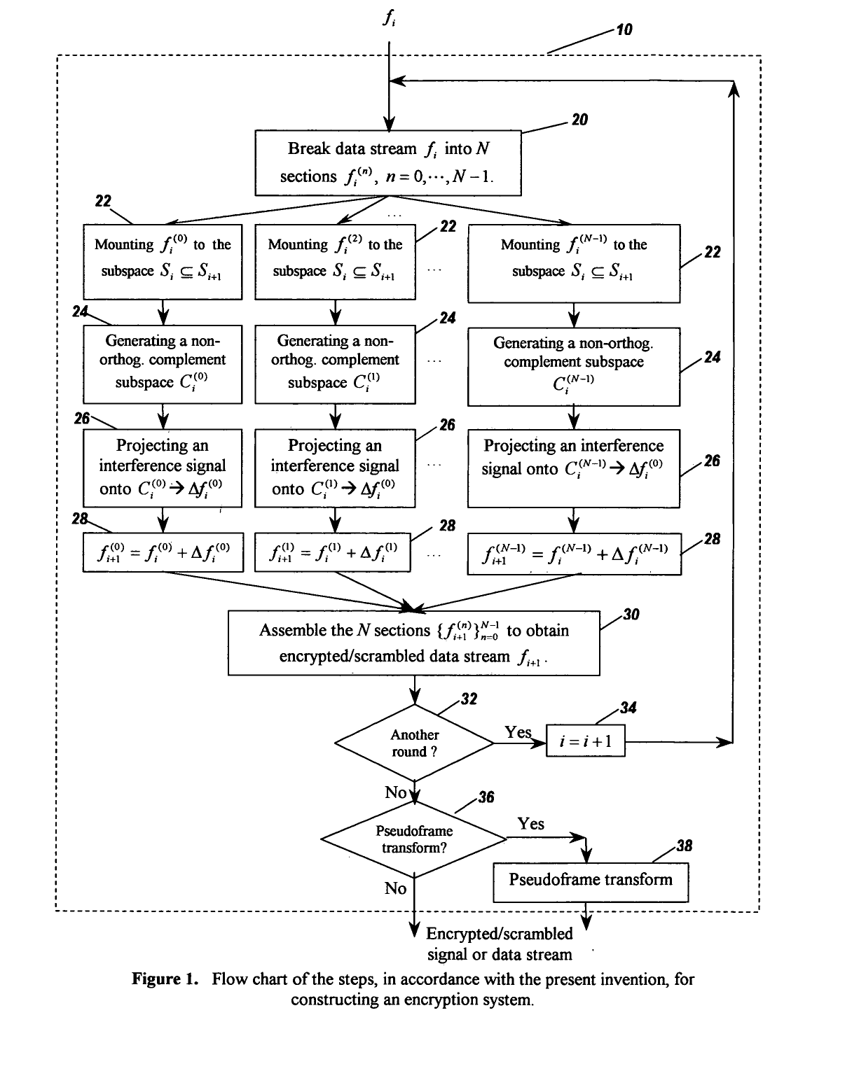

FIG. 1 shows a flow chart of the steps, in accordance with the present invention, for constructing a data/signal encryption system 10. The encryption process includes transforming data/signal f₀ in a subspace S₀ to an irregular subspace S₁, and subsequently to subspaces S₂, S₃, etc. In each of such irregular transformations from Sᵢ to Sᵢ₊₁ (i=0, 1, 2, . . . .), an irregular complement Cᵢ=span{yₖ} of Sᵢ in Sᵢ₊₁ is added to Sᵢ to obtain Sᵢ₊₁, i.e., Sᵢ₊₁=Sᵢ+span{yₖ}, where “+” stands for the (non-orthogonal) direct sum (of two subspaces), and the sequence of vectors {yₖ}ₖ satisfies the condition that span{yₖ}ₖ∩Sᵢ={0}; and that span{yₖ}⊥Sᵢ; i.e., span{yₖ} is not perpendicular to Sᵢ, which opens up nearly infinite many possible ways of selecting {yₖ}ₖ. Then, a random scrambler signal and/or a projection of a partially coherent interference signal onto Cᵢ=span{yₖ}, say Δfᵢ (therefore unknown to senders as well) is added to the signal fᵢ in Sᵢ. The resultant in Sᵢ₊₁ is fᵢ₊₁=fᵢ+Δfᵢ which is not only unreceptive but can also be of reduced energy. The transmitted data/signal can be either fᵢ₊₁ or a further transformation of fᵢ₊₁ through a pseudoframe. The decryption can only be carried out through the use of a number of pseudoframes for subspaces (PFFS). PFFS is a mathematical notion introduced by the inventor in the mathematical and signal processing societies. The references are listed in the Brief Summary Section.

In the first step 20, the data stream/signal fᵢ is broken into N sections fᵢ⁽ⁿ⁾, n=0, . . . , N−1, the size N is user/problem dependent.

In step 22, each sectional signal fᵢ⁽ⁿ⁾ is mounted to the subspace Sᵢ. The mounting mechanism includes extending the vector fᵢ⁽ⁿ⁾ and/or to map fᵢ⁽ⁿ⁾ into Sᵢ (now a subspace in Sᵢ₊₁). This is done by padding on a designed map with a random vector and/or by a designed interleaving vector mapping. Such mappings are determined by the way that the subspace Sᵢ is mounted (associated/placed) in Sᵢ₊₁, which have a large number of ways depending on the dimensionalities Dᵢ and Dᵢ₊₁ of Sᵢ and Sᵢ₊₁, respectively.

One way is to simply append Dᵢ₊₁−Dᵢ zeros or random vectors (making sure that the 0 vector is still contained in the mounted Sᵢ) at the end of original vectors.

Another way is to randomly, or deliberately select Dᵢ₊₁−Dᵢ vector indices I_{C} in the dimension Dᵢ₊₁, and insert zero or random values (making sure again that the 0 vector is still contained in the mounted Sᵢ) at the selected indices of the original vectors.

In step 24, irregular (non-orthogonal) complementary subspaces Cᵢ⁽ⁿ⁾ of Sᵢ in Sᵢ₊₁ are generated for each section of the data stream. One way to generate such a non-orthogonal complementary subspace is to solve a system of linear equations under the conditions that for any element xεSᵢ₊₁, there is a wεSᵢ, and a zεCᵢ⁽ⁿ⁾ such that x=w+z, and that Cᵢ⁽ⁿ⁾∩Sᵢ={0}, i.e., the only common vector between Cᵢ⁽ⁿ⁾ and Sᵢ is the zero vector. The system of equations will have infinite many solutions, a set of solution vectors {yₖ}ₖ (termed y-vectors for convenience), spanning Cᵢ⁽ⁿ⁾ should be those that are not orthogonal to Sᵢ. For convenience, we have not used indices Cᵢ⁽ⁿ⁾ and n in the y-vectors, when in fact there are such indices for the y-vectors for each sectional index n and encryption iteration index i.

Another way of generating a Cᵢ⁽ⁿ⁾ is to follow the theory of Pseudoframes for subspaces with applications, by S. Li and H Ogawa, J. of Fourier Anal. Appl., 10 (2004), no. 4, pp 409-431. In this approach, a (regular) frame system {uₘ}ₘ₌₀^{M-1}(M≧Dᵢ) of Sᵢ is first selected. A frame of Sᵢ is a set of generally overcomplete (more-than-basis) vectors. Then a set of same number of vectors {zₘ}ₘ₊₀^{M-1} from the orthogonal complement of Sᵢ in Sᵢ₊₁ is generated by first finding vectors of the form
zₖ⁰=(0, . . . , 0,1,0, . . . 0),k=0,1, . . . ,Dᵢ₊₁−Dᵢ.
where the only 1 in each such vector appears at the locations specified by the index I_{C}, and {zₘ}ₘ₌₀^{M-1} is generated by linear combinations of {zₖ⁰}ₖ with M set of randomly generated or chosen coefficients {α_{k,m}}_{k,m}:

$${z}_{m} = {\sum }_{k = 0}^{{D}_{i + 1} - {D}_{i}} {α}_{k , m} {z}_{k}^{0} , m = 0 , 1 , … M - 1.$$

Next, we add these two vectors to obtain the x-vectors,
xₘ=uₘ+zₘ,m=0,1, . . . ,M−1.
The x-vectors {xₘ} so generated will also be one of the two pseudoframe sequences used in the decryption process as described in steps 58-72 for the decryption. The step that follows is to generate the y-vectors (which spans Cᵢ⁽ⁿ⁾ by finding a set of vectors orthogonal to the span of {xₘ}. This follows from the system of linear equations [symbol]
xₘ,yₖ [symbol] =0,m=0,1, . . . ,M−1;k=0,1, . . . ,K−1,
where [symbol] a,b [symbol] stands for the inner product of two vectors a and b, and K is the number of vectors in the y-vectors, K≧Dᵢ₊₁−Dᵢ. Again, the solutions will not be unique. The choices of y-vectors are recorded and labeled in an index set J_{y}.

In step 26, for each sectional index (n), a random or a partially coherent interference signal {g}is projected onto the subspace Cᵢ⁽ⁿ⁾ spanned by the y-vectors by the following equation

$$Δ {f}_{i} = {\sum }_{k = 0}^{K - 1} 〈 g , {\tilde{y}}_{k} 〉 {y}_{k} ,$$

where {\tilde{y}ₖ}ₖ₌₀^{K-1} is the standard dual frame of the frame {yₖ}ₖ₊₀^{K-1} in the span of {yₖ}ₖ₌₀^{K-1}. Here the calculation of the standard dual frame is given by
\tilde{y}ₖ=(Y^{H}Y)⁻¹Y^{H}yₖ,k=0,1, . . . ,K−1,
where Y is a matrix formed by stacking y-vectors (in row vector form) row-by-row, and Y^{H} stands for the Hermitian transpose (complex conjugate transpose) of Y. Note that the descriptions here in step 26 did not carry the sectional superscript index (n) and the encryption iteration index i merely for convenience. The general method does as in FIG. 1. It is an extremely important characteristic, in accordance to this invention, that there is no way for attackers to know if a correct set of y-vectors is found. Because Δfᵢ is unidentifiable to anyone including the sender himself/herself.

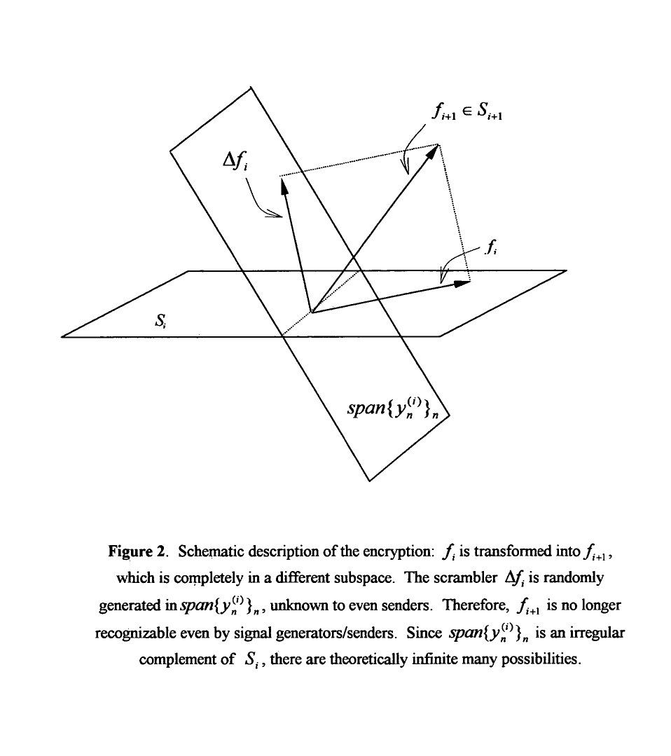

In step 28, the interference signal Δfᵢ created in step 26 is added to the signal data stream at the i^{th} encryption round:
fᵢ₊₁=fᵢ+Δfᵢ.
Note again that the descriptions here in step 28 did not carry the sectional superscript index (n) and the encryption iteration index i merely for convenience. The result of the step 28 produces a signal fᵢ₊₁=fᵢ+Δfᵢ that has leaped into an irregular subspace Sᵢ₊₁, as depicted in FIG. 2.

In step 30, all sectional encrypted/scrambled signals/data streams are assembled to produce one whole piece of encrypted/scrambled signal/data stream.

Step 32 then makes a judgment if the next round of encryption is to be performed. If yes, step 34 changes the index i into i+1, and it leads back to step 20. If not, the encrypted signal/data stream at the end of step 30 will be directed to step 36 for a determination if the final pseudoframe decomposition is desired to be carried out. If not, the result of step 30 is the output of the encryption process. If the answer to step 36 is yes, the following will be carried out in step 38
hₖ=fᵢ₊₁,pₖ,k=0,1, . . . ,K−1,
where {pₖ} is a pseudoframe for the final subspace Sᵢ₊₁ with a dual pseudoframe sequence {qₖ} to be used in the first step 58 of the decryption process if so indicated in the received signal that a pseudoframe decomposition took place at step 38. {hₖ} is the output of the encryption process.

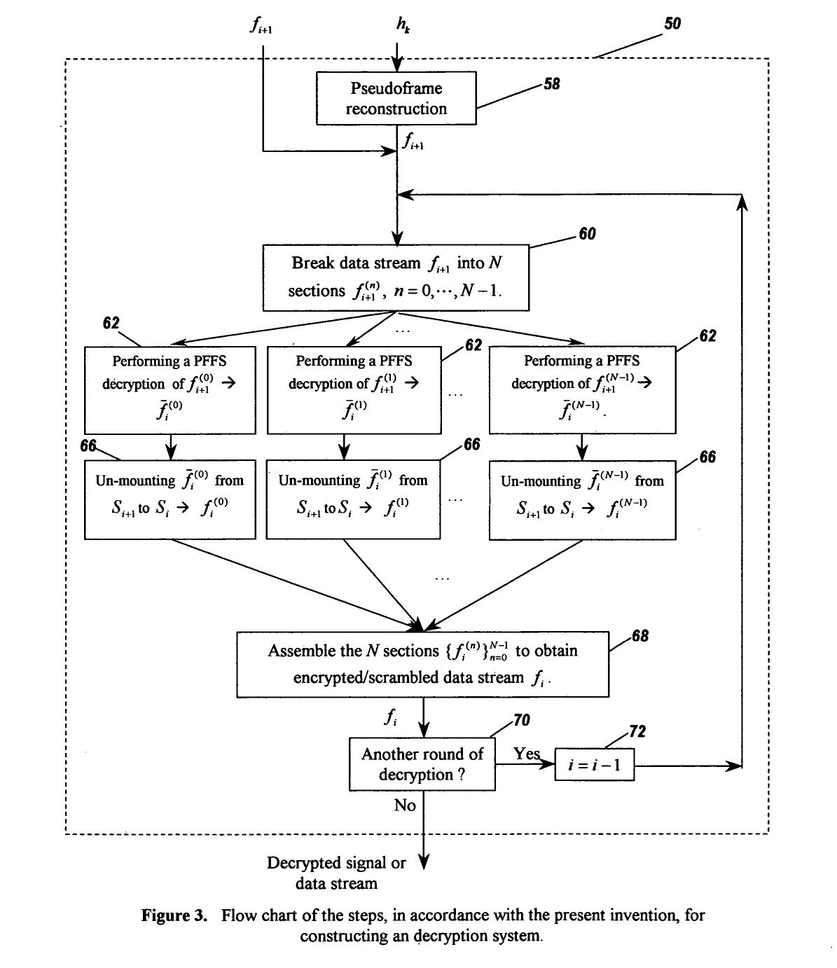

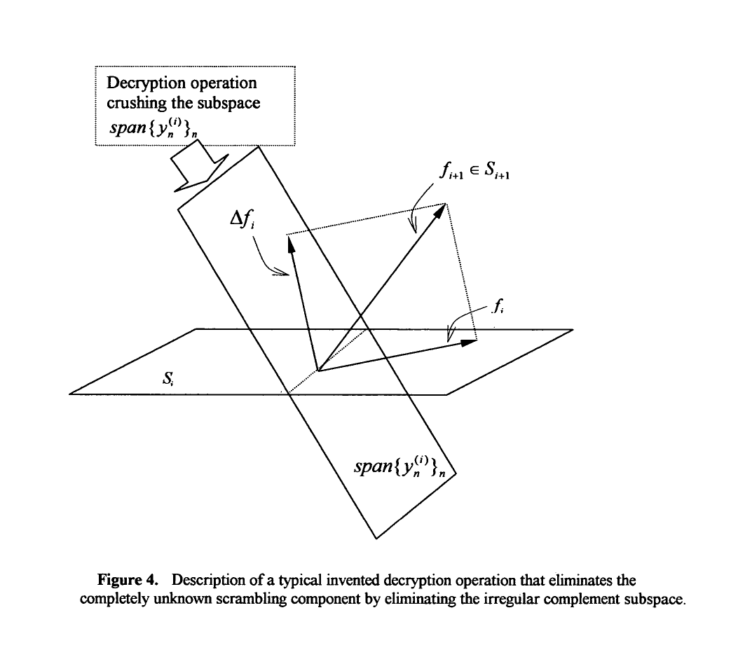

FIG. 3 shows the steps, in accordance with the present invention, for constructing a data/signal decryption system 50. The decryption process starts from a pseudoframe reconstruction, if so indicated as necessary, and then apply another PFFS (given by the x-vectors and its duals) which functions as a non-orthogonal projections Qᵢ (that projects onto Sᵢ with the null space of Qᵢ, N(Qᵢ)⊃span{yₖ}). This preserves the signal component fᵢ and kills all elements in the null spaces of the projections. See FIG. 4, when N(Qᵢ)⊃span{yₖ}, the entire subspace span{yₖ} is eliminated by Qᵢ. The decryption would otherwise be impossible since Δfᵢ is completely unknown to everyone. This is followed by un-mounting the resultant from Sᵢ₊₁ to Sᵢ. Then repeat additional runs of decryptions, if multiple encryption iterations were presented in the signal.

In the first step 58, a pseudoframe reconstruction (if indicated as necessary) is carried out to recover the encrypted signal/data fᵢ₊₁ by

$${f}_{i + 1} = {\sum }_{k} {h}_{k} {q}_{k} .$$

If step 58 is unnecessary, the input fᵢ₊₁ is directly fed into step 60, where the signal/data stream fᵢ₊₁ is broken into N sections fᵢ₊₁⁽ⁿ⁾ in exactly the opposite way as fᵢ₊₁ is assembled during the last encryption process 30, n=0, . . . , N−1.

At the next step 62, a pseudoframe representation is taken to each of the piece fᵢ₊₁⁽ⁿ⁾ to obtain a partially decrypted signal f̅ᵢ⁽ⁿ⁾.

$${Q}_{i} {f}_{i + 1}^{( n )} = {\overline{f}}_{i}^{( n )} = {\sum }_{m} 〈 {f}_{i + 1}^{( n )} , {x}_{m} 〉 {x}_{m}^{*} ,$$

where {xₘ} is the x-vector generated in the encryption process, and {xₘ*} is a dual pseudoframe sequence of {xₘ} for the subspace Sᵢ given by the following formula (as described in “Pseudoframes for subspaces with applications”, by S. Li and H. Ogawa, J. of Fourier Anal. Appl., 10 (2004), no. 4, pp 409-431):

$${x}_{m}^{*} = {Q}_{i} {x}_{m}^{0} + {ξ}_{m} - {\sum }_{n} 〈 {Q}_{i} {x}_{m}^{0} , {x}_{m} 〉 {ξ}_{m} ,$$

where {ξₘ} is an arbitrary vector in Sᵢ₊₁, and {xₘ⁰} is the standard dual frame of the frame sequence {xₘ} calculated by
xₘ⁰=(X^{H}X)⁻¹X^{H}xₘ,m=0,1, . . . ,M−1,
and X is a matrix formed by stacking the x-vectors (in row vector form) row-by-row, and X^{H} stands for the Hermitian transpose (complex conjugate transpose) of X.

The notion of pseudoframes for subspaces is generally known as follows. Let S be a signal subspace in H (a vector space for instance). Let {xₙ} and {xₙ*} be two sequences of vectors in H (not necessarily in S). {xₙ} is a pseudoframe for the subspace S (PFFS) with respect to {xₙ*} if

$$∀ f ∈ S , \\ f = {\sum }_{n} 〈 f , {x}_{n} 〉 {x}_{n}^{*} . \qquad ( 1 )$$

There are a few features of PFFS that are critical in the present invention. First, {xₙ} and {xₙ*} are not necessarily in S, unlike conventional frames of a subspace (a conventional frame requires that (1) holds for all fεS with sequences {xₓ} and {xₙ*} both in S). Thereby, the span of {xₙ} needs not contain S nor be contained in S. This gives rise to infinite flexibility and very different geometric properties of a PFFS than that of frames and/or bases. Furthermore, PFFS generates naturally a non-orthogonal projection onto the subspace S. Precisely speaking, if Q is a projection (onto S along the null space of Q, N(Q)), then,

$$∀ f ∈ H , \\ Qf = {\sum }_{n} 〈 f , {Q}^{*} {x}_{n} 〉 {x}_{n}^{*} . ,$$

where Q is the adjoint operator of Q. Q* is also a projection whose range is N(Q)^{⊥} and whose direction is S^{⊥}. In a special case, if N(Q)=span{xₙ}^{⊥}, then the range of Q*, being the orthogonal complement of N(Q)^{⊥}, is therefore simply span{xₙ}. Hence, Q*xₙ=xₙ. A non-orthogonal projection onto S is thus given by such a PFFS

$$∀ f ∈ H , \\ Qf = {\sum }_{n} 〈 f , {x}_{n} 〉 {x}_{n}^{*} .$$

This last equation is the operation described earlier in step 62.

In step 66, the partially decrypted signal f̅ᵢ⁽ⁿ⁾ is un-mounted from Sᵢ₊₁ back into Sᵢ to obtain fᵢ⁽ⁿ⁾ in the opposite way that a data/signal is mounted to Sᵢ₊₁.

Then in step 68, the N pieces of signal/data stream from step 66 are assembled together to finish one round of decryption. A judgment step 70 is followed to determine if additional round of decryption is necessary. If not, the result of step 68 will be the final output; If yes, step 72 changes the index i into i−1, and leads the process back to step 60.

The present invention as described above is secure because of the nearly infinite many possible irregular subspace leaping and the vector mounting permutations. The security of the present invention is also ensured by the fact that the encrypting/scrambling data component Δfᵢ at each iteration is unknown to anyone including the sender. An attacker would not have a reference to determine if a correct set of x-vectors is being found for the decryption since Δfᵢ is completely unknown. Analysis below shows the complexity of the invented decryption method besides the fact that Δfᵢ is unknown. Assume that the signal/data vector fᵢ is in the Euclidian vector space of dimension n. Assume that the next subspace Sᵢ₊₁ has the dimension m+n. Then fᵢ is to be mounted to Sᵢ₊₁ first. Assume that only zeros are inserted to expand the vector fᵢ into Sᵢ₊₁ (permutations of components of fᵢ is not yet considered). There are

$$\frac{( n + m ) !}{n ! m !}$$

many ways to place the m zeros. For each such way of inserting zeros in the mounting process, there are (2^{m}−1) ways of assigning values to the y-vectors at the m positions of zeros inserted during the mounting process (each of the m entries has 2 possibilities between 0 and 1 (non-zero), except that y-vectors can not have all zeros at all m positions of the mounting process since y-vectors are not in the same space of the mounted fᵢ). Then for each such way of choosing the y-vectors at the said m positions, there are 2ⁿ ways of assigning the rest entries of the y-vectors. Thereby, there are all together

$$\frac{( n + m ) !}{n ! m !} \cdot {2}^{n} ( {2}^{m} - 1 )$$

ways of selecting the y-vectors. We have not yet considered the high number of combinations of y-vectors used in each of the encryption steps.

Now, for each choice of y-vectors, decryption needs the determination of x-vectors and its duals, and also a pseudoframe expansion. These calculations involve two pseudo-inverse operations and some matrix multiplications, which takes certain time to carry out. Consider a simple example where n=128, and m=2 (only). In today's computing technology, it takes the order of 10⁻¹ or 10⁻² seconds to carry out the pseudo-inverse and matrix multiplications. Take the smaller 10⁻² seconds for instance, the total time will translate into

$$\frac{( 128 + 2 ) !}{128 ! 2 !} \cdot {2}^{128} ( {2}^{2} - 1 ) \cdot {10}^{- 2} ( sec ) = 2.71 \times {10}^{33} ( yr ) = 2.71 \times {10}^{24} ( billion yr ) .$$

Such a complexity is compounded with the permutations of components of fᵢ during the mounting procedure. There are n! possible ways of permutations of the vector fᵢ. In the above example with n=128, 128-factorial is in the order of 10²¹⁵, a truly large number even though each permutation may not take long to carry out.

### AN EXAMPLE

Showing below is an example with 8 digits. After the encryption in accordance with the present invention, even a slight difference in the decryption projection direction (as shown below) will result in very different output. On top of each matrix, there is a title box explaining what the underneath matrix is. Note that each incorrect decryption x-vectors differs with the correct x-vectors by only one digit that is written in bolded italic arial font. The result of the decryption differs dramatically.

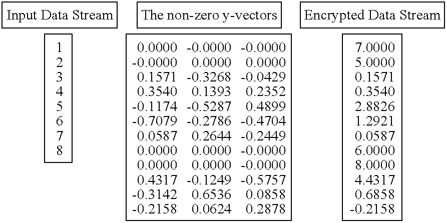

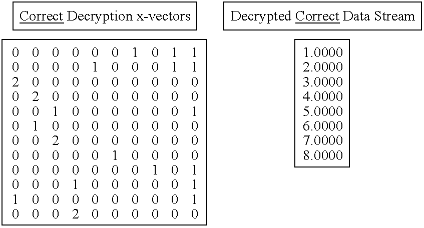

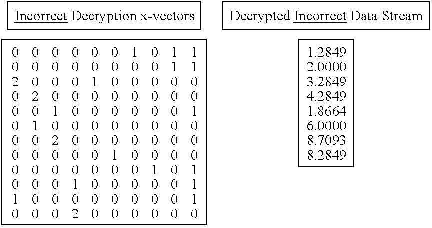

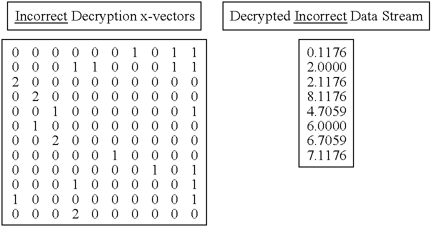

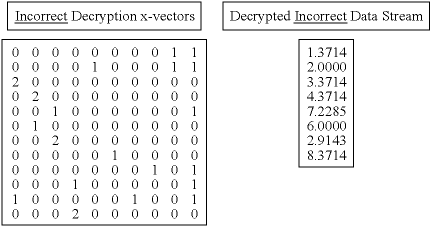

Variations of the Encryption and Decryption Procedures

The simplest procedure is to select one set of {yₙ^{(j)}}ₙ only and perform one step of transformation before transmission. The index j will be given to the recipient, and the correct PFFS decryption can be applied for the decryption. To simple and less critical applications such as cell phone communications, this procedure may serve the encryption purpose very well since it already requires billions and billions of years to try out all possibilities.

One other procedure is to select or randomly select a set of {yₙ^{(j)}}ₙ without recording the index j. The encryption process performs the scrambling in the increasing order in which the index j presents. The recipient would not know the index set. The decryption procedure performs the non-orthogonal projections sequentially from the largest j till j=1.

Another procedure is to select a set of {yₙ^{(j)}}ₙ with jεJ_{y}. The index set J_{y} and its order will be given to the recipient. The decryption procedure is as described in steps 50-72.

Encryption and decryption procedures can also be combinations of the above.

Invention Used in Authentication

The index set J_{y} identifies the set of {yₙ^{(j)}}ₙ used in the encryption. The nearly infinite many possible choices of J_{y} can be used in authentication. When the index set J_{y} is assigned to person A, recipients would know that the message truly come from A if the message can be decoded using the index set J_{y}. Conversely, if a message is sent to A using A's index J_{y}, then only A can decode the message.

Variations of Invention Apparatus

1. Software Package A software package that can be applied in computer and network environments, such as internet data communications, encrypted telephone communications, banking data communications, and all other network related communications. Such a software package will mostly be used as an independent encryption and decryption tool. It can also be served as a plug-in.

2. Software Plug-in A software package that can be plugged into certain applications to add the security functionality and/or to complement existing common security products.

3. Specialized Software Plug-in A software plug-in written to incorporate prescribed security functionalities. This can also be integrated with existing specialized encryption mechanism.

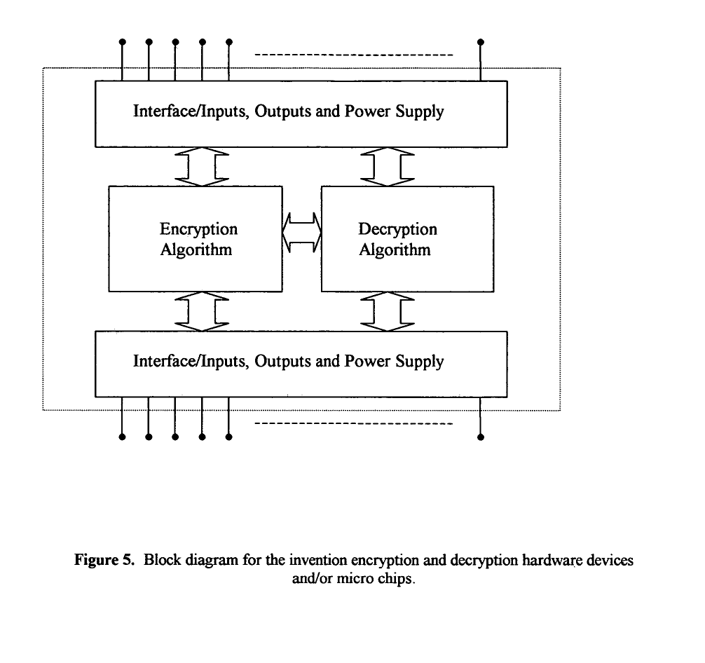

4. Hardware devices and Microchips A hardware device, an ASIC, FPGA or other form of microchips that encrypts outgoing signals and decrypts received signals. The block diagram of the hardware devices and/or chips is given in FIG. 5. Such an invention hardware/chip can be applied in cell phone handsets, remote sensing devices, telephone sets, communication relay devices, and any other hardware device that transmits and receives data/signals wirelessly or via wired lines.

Although the present invention has been described in considerable detail with reference to certain preferred versions thereof, other versions are possible. Therefore, the spirit and scope of the appended claims should not be limited to the description of the preferred versions contained herein.

What is claimed is:

1. A method for data/signal encryption and/or scrambling for secure data/signal transmissions over the wired and wireless communication and internet networks, comprising
a. a transformation of the first data/signal in the first subspace into a second data/signal in the second (and different) subspace;
b. a construction of the said second subspace via a non-orthogonal direct sum of the first subspace and a non-orthogonal complement (subspace) of the first subspace in the second subspace;
c. a construction of the said non-orthogonal complement subspace via a sequence of y-vectors in the second subspace that shares with the first subspace only the zero vector;
d. generating a scrambling signal randomly in the said non-orthogonal complement subspace spanned by the said y-vectors, and/or take a projection of a partially coherent interference signal onto the said complement subspace spanned by the said y-vectors;
e. adding the said scrambling signal, which is non-orthogonal to the first data/signal, to the first data/signal;
whereby the second data/signal is completely unrecognizable even by the data/signal generator/sender, and
whereby the second data/signal or a further pseudoframe transformation of the second data/signal can be securely transmitted through the said networks.

2. A method for data/signal encryption/scrambling for secure data/signal transmissions over the wired and wireless communication and internet networks as recited in claim 1, further comprising recursively
a. a sequence of transformations of the first data/signal in the first subspace into a final data/signal in the final and different subspace through a sequence of intermediate subspaces;
b. a construction of the said sequence of intermediate subspaces via non-orthogonal direct sums of the first/previous intermediate subspace and a non-orthogonal complement subspace of the first/previous intermediate subspace in the subsequent intermediate subspace;
c. a construction of the said non-orthogonal complement subspace via a sequence of y-vectors in the subsequent intermediate subspace that shares only the zero vector with the first/previous intermediate subspace;
d. a set of sequences of said y-vectors that spans the said non-orthogonal complement subspaces in each said step of the generation of said sequence of intermediate subspaces;
e. generating a scrambling signal randomly in each said complement subspace spanned by each set of the said y-vectors, and/or take a projection of a partially coherent signal onto the said complement subspace spanned by each set of the said y-vectors;
f. adding each said scrambling signal generated in each said complement sub pace to the first/previous data/signal in the first/previous intermediate subspace;
whereby the final data/signal is completely unrecognizable even by the data/signal generator/sender, and
whereby the final data/signal or a further pseudoframe transformation of the final data/signal can be securely transmitted through the said networks.

3. A method for data/signal decryptions to decode received data/signals that are encrypted by said method as recited in claim 1, comprising
a. a recovery of the scrambled signal through a pseudoframe reconstruction if so indicated in the received signal that a pseudoframe transformation took place before the transmission;
b. a construction of a sequence of x-vectors whose span equals to the orthogonal complement of the span of y-vectors (used in the encryption) in the transmitted signal subspace, and whose span covers the original subspace through an orthogonal projection;
c. a construction, using the said x-vectors, of a pseudoframe for the subspace where the original data/signal resides in;
d. the evaluation of a dual pseudoframe of the said x-vectors for the said original subspace;
e. a construction of a non-orthogonal projection whose range subspace is the original subspace and whose null subspace contains the span of the said y-vectors through the said pseudoframe for subspace;
f. a linear operation through the said pseudoframe expansion that performs a non-orthogonal projection of the received data/signal onto the original subspace;
whereby the original data/signal is recovered.

4. A method for data/signal decryptions as recited in claim 3 to decode received data/signals that are encrypted by the recursive method as recited in claim 2, including
a. a recovery of the scrambled signal through a pseudoframe reconstruction if so indicated in the received signal that a pseudoframe transformation took place before the transmission;
further comprising recursively
b. constructing a sequence of x-vectors for each said transformation in claim 2 between each pair of said consecutive intermediate subspaces; and
c. each set of said x-vectors has a span equaling to the orthogonal complement of the span of each set of corresponding y-vectors (used in the encryption) in the said subsequent intermediate subspace, and the span of each said x-vectors covers the said previous intermediate subspace through an orthogonal projection;
d. a construction, between each said pair of consecutive intermediate subspaces, of a pseudoframe for the said previous intermediate subspace using the said x-vectors;
e. the evaluation, between each said pair of consecutive intermediate subspaces, of a dual pseudoframe of the said x-vectors for the said previous intermediate subspace;
f. a construction, between each said pair of consecutive intermediate subspaces, a non-orthogonal projection whose range subspace is the previous intermediate subspace and whose null subspace contains the span of the said y-vectors in the said subsequent intermediate subspace;
g. a sequence of linear operations through said pseudoframe expansions that perform a sequence of non-orthogonal projections of the received data/signal onto the said previous intermediate subspace, until reaching the indicated step;
whereby the original data/signal is recovered.

5. A method for data/signal encryption/scrambling as recited in claim 2,
a. wherein the set of y-vectors are labeled and ordered in the index set J_{y}; and
b. wherein only a random subset of J_{y} is selected and used in the recursive encryption procedure following the order of the indices in the said subset.

6. A method for data/signal decryption as recited in claim 4 to decode encrypted data/signals that are encrypted by the method as recited in claim 5,
a. wherein the set of x-vectors associated with the said y-vectors are labeled in the same order of the y-vectors; and
b. wherein the decryption follows the reverse order of the entire index set J_{y} until reaching the first index and recovering the original data/signal.

7. A method for data/signal encryption and decryption as recited in claims 1-6, wherein the steps of generating x-vectors and y-vectors include
a. generating a set frame vectors for the first/previous subspace;
b. computing a set of orthogonal vectors to the first/previous subspace,
c. adding the said orthogonal vectors to the frame vectors to form x-vectors;
d. determining y-vectors from solving a system of linear equations by the principle that y-vectors are orthogonal to the said x-vectors and that y-vectors spans a complementary subspace of the first/previous subspace in the second/subsequent subspace.

8. A method for data/signal encryption as recited in claims 1 and 2, wherein the steps of generating encrypting/scrambling signals include
a. forming a random linear combination of the set of y-vectors used in the encryption; or
b. taking a piece of partially coherent interference signal g that is not completely reside in the first/previous signal subspace;
c. representing the y-vectors as a frame matrix Y;
d. determining the dual frame vectors {\tilde{y}ₖ} of the y-vectors {yₖ} by the matrix operation \tilde{y}ₖ=(Y^{H}Y)⁻¹Y^{H}yₖ, k=0, 1, . . . , K−1,
e. computing the projection of the said interference signal g onto the span of y-vectors
$$by Δ {f}_{i} = {\sum }_{k = 0}^{K - 1} 〈 g , {\tilde{y}}_{k} 〉 {y}_{k} .$$

9. A method for data/signal decryption as recited in claims 3, 4 and 6, wherein the steps of generating a dual pseudoframe sequence {xₘ*} to the said x-vectors include
a. representing the x-vectors as a frame matrix X;
b. determining the standard dual frame sequence {xₘ⁰} of the frame sequence {xₘ} by the matrix computation xₘ⁰=(X^{H}X)⁻¹X^{H}xₘ, m=0, 1, . . . , M−1;
c. computing a dual pseudoframe {xₘ*m} by the formula
$${x}_{m}^{*} = {Q}_{i} {x}_{m}^{0} + {ξ}_{m} - {\sum }_{n} 〈 {Q}_{i} {x}_{m}^{0} , {x}_{m} 〉 {ξ}_{m} ,$$
where {ξₘ} is an arbitrary vector in the second/subsequent subspace, and Qᵢ is a projection from the second/subsequent subspace to the first/previous subspace.

10. A software product that implements the said methods as recited in claim 1 and claim 3, including
a. an independent encryption and decryption software operating in computer and internet network environments;
b. a plug-in encryption and decryption software that can be installed in computer and internet network environments to integrate with other software products for added functionality of data encryption and decryption;
c. a specialized plug-in encryption and decryption software that can be integrated with specialized devices and/or other security software products for enhanced safety functionality;
whereby the said software can be installed and used in computer, internet and communication networks for added or enhanced security functionality.

11. A software product that implements the said recursive methods as recited in claim 2 and claim 4, or claim 5 and claim 6, including
a. an independent encryption and decryption software operating in computer, internet and communication network environments for data encryption and decryption;
b. a plug-in encryption and decryption software that can be installed in computer internet and communication network environments to integrate with other software products for added functionality of data encryption and decryption;
c. a specialized plug-in encryption and decryption software that can be integrated with specialized devices and/or other security products for enhanced security functionality;
whereby the said software can be installed and used in computer, internet and communication networks for added or enhanced security functionality.

12. A device that implements the said methods as recited in claim 1 and claim 3, including
a. input terminals for the said methods of encryption and decryption, including input signal/data port and control ports;
b. output terminals for the said methods of encryption and decryption, including output signal/data port and control ports;
c. an encryption body, and a decryption body for the said methods;
d. a communication port between the said encryption and the said decryption bodies,
e. a power supply;
whereby the said device can be used in communication devices and networks for added or enhanced security functionality.

13. A device that implements the said recursive methods as recited in claim 2 and claim 4, or claim 5 and claim 6, including
a. input terminals for the said methods of encryption and decryption, including input signal/data port and control ports;
b. output terminals for the said methods of encryption and decryption, including output signal/data port and control ports;
c. an encryption body, and a decryption body for the said methods of compounded encryption and decryption;
d. a communication port between the said encryption and the said decryption bodies,
e. a power supply;
whereby the said device can be used in communication devices and networks for added or enhanced security functionality.

14. A microchip that implements the said methods as recited in claim 1 and claim 3, including
a. input terminals for the said methods of encryption and decryption, including input signal/data port and control ports;
b. output terminals for the said methods of encryption and decryption, including output signal/data port and control ports;
c. an encryption body, and a decryption body for the said methods;
d. a communication port between the said encryption and the said decryption bodies,
e. a power supply;
whereby the said microchip can be used in communication devices, line phone, wireless phones and networks for added or enhanced security functionality.

15. A microchip that implements the said recursive methods as recited in claim 2 and claim 4, or claim 5 and claim 6, including
a. input terminals for the said methods of encryption and decryption, including input signal/data port and control ports;
b. output terminals for the said methods of encryption and decryption, including output signal/data port and control ports;
c. an encryption body, and a decryption body for the said compounded encryption and decryption methods;
d. a communication port between the said encryption and the said decryption bodies,
e. a power supply;
whereby the said microchip can be used in communication devices, line phones, wireless phones and networks for added or enhanced security functionality.
